(19) United States
(12) Patent Application Publication
(10) Pub. No.: US 2023/0177419 A1
(43) Pub. Date: Jun. 8, 2023

(54) SYSTEMS AND METHODS FOR CUSTOMIZING AND DISPLAYING USER LEARNING PATHS

(71) Applicant: Capital One Services, LLC, McLean, VA (US)

(72) Inventors: Joerg Rings, Chicago, IL (US); Ariel M'ndange-Pfupfu, Washington, DC (US); Chi Zhang, Falls Church, VA (US)

(21) Appl. No.: 17/544,351

(22) Filed: Dec. 7, 2021

(51) Int. Cl. G06Q 10/06; G06N 5/02; G06Q 10/10

(52) U.S. Cl. CPC G06Q 10/063114; G06N 5/022; G06Q 10/105

(57) ABSTRACT

Disclosed herein are systems and methods that can classify a plurality of nodes in a knowledge graph, where each of the plurality of nodes representative of an education medium, establish a plurality of links in the knowledge graph, where each of the plurality of links connects to at least two nodes of the plurality of nodes and each of the plurality of links represents an education relationship between the at least two nodes, receive, from a computing device associated with a user, data representative of qualifications associated with the user, determine a first set of nodes from the plurality of nodes, the first set of nodes representative of education mediums known by the user, create a user path through the knowledge graph, and assign, to each node in the second set of nodes, a chronological identity representative of an order by which the user proceeds through the user path.

### FIELD OF THE DISCLOSURE

The present disclosure relates generally to systems and methods for customizing and displaying user learning paths; and particularly, to knowledge graph database systems and methods for storing and presenting learning data.

### BACKGROUND

In any industry, there is an important period of time for new employees when joining a company. Getting new employees up to speed and integrated into the company is a top priority. The quicker new employees can learn, the faster the new employees can contribute to productivity. In most cases, new employees are trained using various digital classes across a variety of mediums. The digital classes are usually put together by the company and rarely updated. The new employees must complete prescribed sets of classes before they can begin contributing to their teams fully.

However, static learning paths or sets of classes must either make assumptions about the new employees or, by necessity, contain content that is not optimal or redundant for the learner. While the former leads to large inefficiencies in maintaining multiple similar learning paths, the latter leads to inferior learning opportunities. This problem exists because every learner or new employee arrives with a different set of previous knowledge, prior experience, and a different context in which they access content. These circumstances are often further modified by the employees' current job specifics and project, as well as the time that they can commit to the learning.

What is needed, therefore, are systems and methods that can customize learning paths and the learning experience for a user based on the prior knowledge and experiences of the user. Embodiments of the present disclosure address this need as well as other needs that will become apparent upon reading the description below in conjunction with the drawings.

### BRIEF SUMMARY

The present disclosure relates generally to systems and methods for customizing and displaying user learning paths; and particularly, to knowledge graph database systems and methods for storing and presenting learning data.

An example of the present disclosure can provide a method for generating a user path, the method including classifying a plurality of nodes in a knowledge graph, each of the plurality of nodes representative of an education medium, establishing a plurality of links in the knowledge graph, each of the plurality of links connecting to at least two nodes of the plurality of nodes, where each of the plurality of links is representative of an education relationship between the at least two nodes, displaying, on a graphical user interface (GUI) at a computing device associated with a user, a display including the plurality of nodes and the plurality of links, receiving, from the computing device associated with the user, data representative of qualifications associated with the user, determining, based on the qualifications associated with the user, a first set of nodes from the plurality of nodes, the first set of nodes being representative of education mediums known by the user, filtering out, from the GUI, the first set of nodes such that the first set of nodes are no longer visible on the GUI, creating a user path through the knowledge graph, the user path comprising a second set of nodes from the plurality of nodes, where each node in the second set of nodes is connected by a link from the plurality of links, highlighting, on the GUI, the user path comprising the second set of nodes connected by the plurality of links, and assigning, to each node in the second set of nodes, a chronological identity representative of an order by which the user proceeds through the user path, wherein the user path is representative of a learning curriculum comprising the education medium associated with each of the second set of nodes.

Another example of the present disclosure can provide a knowledge graph system including a processor, a database, and a memory storing instructions that, when executed by the processor, cause the knowledge graph system to classify a plurality of nodes in a knowledge graph, where each of the plurality of nodes representative of an education medium, establish a plurality of links in the knowledge graph, where each of the plurality of links connects to at least two nodes of the plurality of nodes and each of the plurality of links represents an education relationship between the at least two nodes, receive, from a computing device associated with a user, data representative of qualifications associated with the user, determine, based on the qualifications associated with the user, a first set of nodes from the plurality of nodes, the first set of nodes representative of education mediums known by the user, create a user path through the knowledge graph, the user path including a second set of nodes from the plurality of nodes, where each node in the second set of nodes is connected by a link from the plurality of links, and assign, to each node in the second set of nodes, a chronological identity representative of an order by which the user proceeds through the user path, wherein the user path is representative of a learning curriculum comprising the education medium associated with each of the second set of nodes.

Another example of the present disclosure can provide a method of generating a learning curriculum, the method including receiving, from a first computing device associated with a contributor, a first education medium comprising data representative of a contents of the first education medium, storing, in a database, the first education medium, classifying, based on the data representative of the contents of the first education medium, the first education medium into a first node in a knowledge graph, the first node including a query path to the first education medium in the database, and establishing, based on the contents of the first education medium, one or more links from the first node to one or more nodes in the knowledge graph, each of the one or more links representative of a relationship between the first education medium and one or more education media associated with the one or more nodes.

These and other aspects of the present invention are described in the Detailed Description below and the accompanying figures. Other aspects and features of embodiments of the present invention will become apparent to those of ordinary skill in the art upon reviewing the following description of specific, exemplary embodiments of the present invention in concert with the figures. While features of the present invention may be discussed relative to certain embodiments and figures, all embodiments of the present invention can include one or more of the features discussed herein. Further, while one or more embodiments may be discussed as having certain advantageous features, one or more of such features may also be used with the various embodiments of the invention discussed herein. In similar fashion, while exemplary embodiments may be discussed below as device, system, or method embodiments, it is to be understood that such exemplary embodiments can be implemented in various devices, systems, and methods of the present invention.

### BRIEF DESCRIPTION OF THE DRAWINGS

The accompanying drawings, which are incorporated in and constitute a part of this specification, illustrate multiple embodiments of the presently disclosed subject matter and serve to explain the principles of the presently disclosed subject matter. The drawings are not intended to limit the scope of the presently disclosed subject matter in any manner

FIG. 1 is an example knowledge graph in accordance with some examples of the present disclosure.

FIG. 2 is an example display of a user path in accordance with some examples of the present disclosure.

FIG. 3 illustrates a system diagram of a computing device in accordance with some examples of the present disclosure.

FIG. 4 illustrates a system diagram of a knowledge graph system in accordance with some examples of the present disclosure.

FIG. 5 illustrates a flowchart of a method for generating a user path in accordance with some examples of the present disclosure.

FIG. 6 illustrates a flowchart of a method of generating a learning curriculum in accordance with some examples of the present disclosure.

### DETAILED DESCRIPTION

As described above, a problem with current learning systems is that static learning paths must either make close assumptions about the new employees or, by necessity, contain content that is not optimal or redundant for the learner. While the former leads to large inefficiencies in maintaining multiple similar learning paths, the latter leads to inferior learning opportunities. This greatly reduces the productivity of new employees getting up to speed. Either learners waste time on learning material that is already known, learners are unprepared for their current projects, or the company must consume large amounts of resources to custom tailor the learning material for each employee.

Thus, the present disclosure can provide learning content for any given domain of knowledge. The learning content can be organized in small, contained units (micro content) which is stored in a knowledge graph. In the knowledge graph, the nodes represent a piece of content and its metadata, and the edges represent relations between the content. Such relations can include, for example, “follows,” “is a prerequisite,” or “is an example of,” among others. The context assigned to a user wishing to traverse the content can encompass, for example, job family, years of experience, current time availability, or current project type, among others. The disclosed systems and methods can create a walk through the learning material that represents a personalized learning path. The learning path can then be visually displayed to the user to aid their progression along the learning path. To create an optimal path, each piece of content can be assigned metadata that allows a computing device to create the optimal path based on certain constraints. Such constraints can include, for example, a level of difficulty, a topic, and a time demand for each content piece.

Therefore, examples of the present disclosure can provide systems and methods for generating a user path, including classifying a plurality of nodes in a knowledge graph, each of the plurality of nodes representative of an education medium, establishing a plurality of links in the knowledge graph, each of the plurality of links connecting to at least two nodes of the plurality of nodes, where each of the plurality of links is representative of an education relationship between the at least two nodes, displaying, on a graphical user interface (GUI) at a computing device associated with a user, a display including the plurality of nodes and the plurality of links, receiving, from the computing device associated with the user, data representative of qualifications associated with the user, determining, based on the qualifications associated with the user, a first set of nodes from the plurality of nodes, the first set of nodes being representative of education mediums known by the user, filtering out, from the GUI, the first set of nodes such that the first set of nodes are no longer visible on the GUI, creating a user path through the knowledge graph, the user path comprising a second set of nodes from the plurality of nodes, where each node in the second set of nodes is connected by a link from the plurality of links, highlighting, on the GUI, the user path comprising the second set of nodes connected by the plurality of links, and assigning, to each node in the second set of nodes, a chronological identity representative of an order by which the user proceeds through the user path, wherein the user path is representative of a learning curriculum comprising the education medium associated with each of the second set of nodes.

Although certain embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. Other embodiments of the disclosure are capable of being practiced or carried out in various ways. Also, in describing the embodiments, specific terminology will be resorted to for the sake of clarity. It is intended that each term contemplates its broadest meaning as understood by those skilled in the art and includes all technical equivalents which operate in a similar manner to accomplish a similar purpose.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

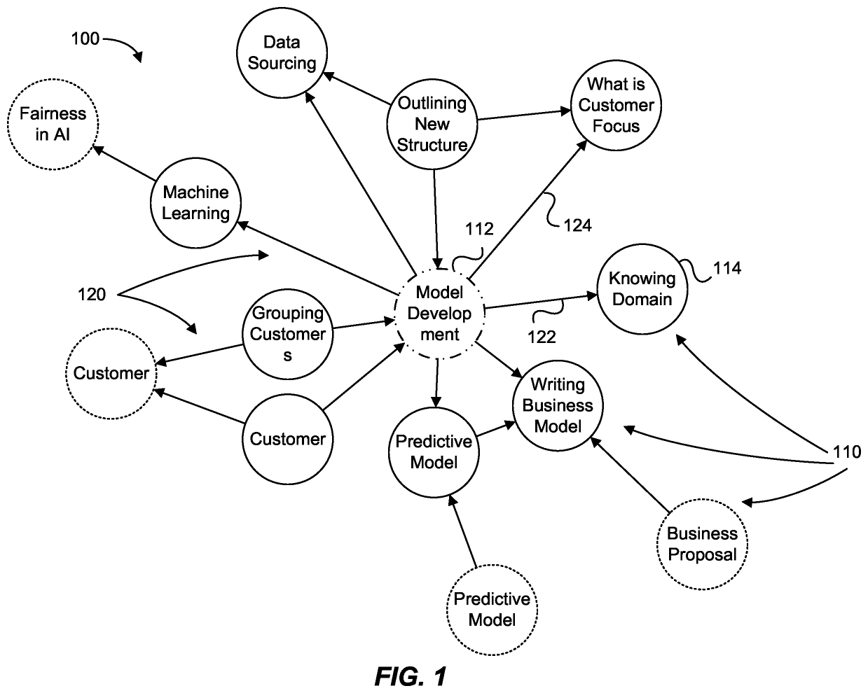

FIG. 1 illustrates an example knowledge graph 100. As shown, the knowledge graph 100 can comprise a plurality of nodes 110 (e.g., a first node 112 and a second node 114) and a plurality of links 120 (e.g., a first link 122 and a second link 124). Each of the plurality of nodes 110 can represent an education medium. For example, the plurality of nodes 110 can each represent pieces of learning content, such as presentation recordings, slideshows, videos, quizzes, and the like. Alternatively, or in addition, each of the plurality of nodes 110 can comprise metadata associated with the education medium. The metadata can include, for example, a type of content, a level of difficulty, an intended audience, a time to complete, or an author of the education medium. The different levels of metadata are illustrated in FIG. 1 as different dashed lines surrounding each node. For example, white papers can be denoted by a mixed dotted and dashed line, video recordings can be denoted by a solid line, and slide decks or presentations can be denoted by a dashed line.

Each of the plurality of links 120 can connect to at least two nodes of the plurality of nodes 110. For example, the first link 122 can connect the first node 112 and the second node 114, and the second link 124 can connect the first node 112 and a third node. Each of the links can represent an educational relationship between the at least two nodes. For example, the first link 122 can indicate that the second node 114 is an example of the concept in the first node 112. Alternatively, or in addition, the second link 124 can be the opposite of the first link 122, linking the second node 114 back to the first node. For example, the second link 124 can indicate that the first node 112 conceptualizes the second node 114. In such a manner, the knowledge graph 100 can classify learning material in the plurality of nodes 110 and establish the relationships between them using the plurality of links 120.

The knowledge graph 100 can be displayed on a graphical user interface (GUI) such that the plurality of nodes 110 and the plurality of links 120 are visible to a user. The knowledge graph 100 can be illustrated as shown in FIG. 1 or in other manners contemplated by those of skill in the art. The GUI can further display the metadata associated with each of the plurality of nodes 110 or the plurality of links 120, as well as other information described above. For example, a given node can be labeled “Coding 101” on the GUI with additional display elements indicating “Level of Difficulty: Easy” and “Time to Complete: 10 Minutes.”

The GUI can also be modified to create a user path through the knowledge graph 100. The plurality of nodes 110 can be altered based on qualifications associated with the user. For example, certain nodes can be filtered out from the GUI such that the nodes are no longer visible. The nodes that are left on the GUI can correspond to a user path through the learning material for the user to follow. Such an example is discussed in greater detail below.

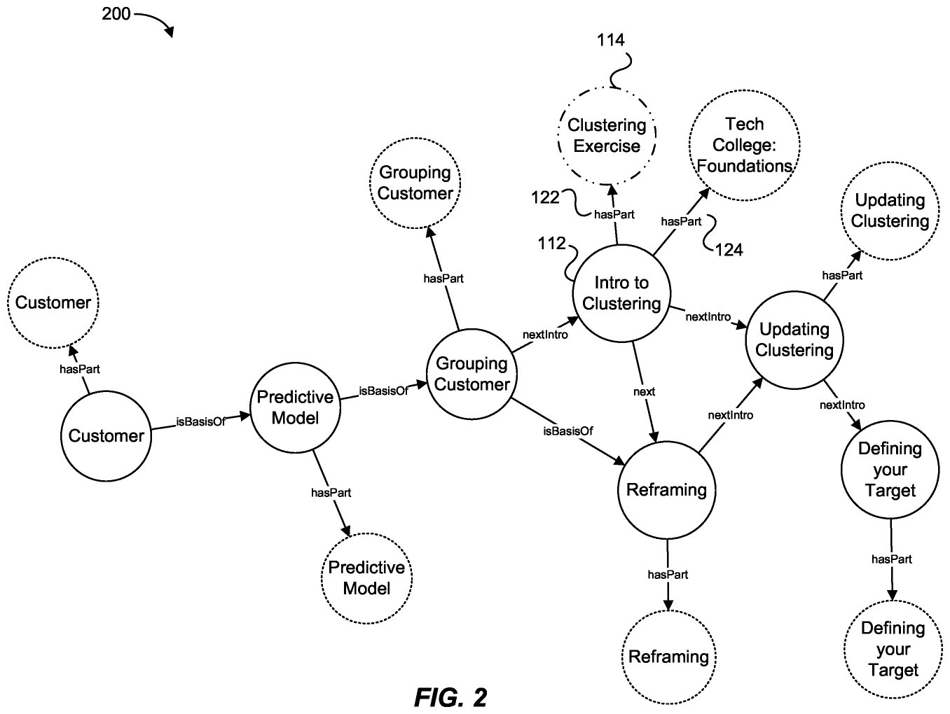

FIG. 2 illustrates a user path 200 through the knowledge graph 100. The user path 200 can comprise a set of nodes connected by a set of links. The set of nodes can be the results of filtering the plurality of nodes 110 based on the qualifications associated with the user. The user path 200 can be highlighted or emphasized on the GUI in some manner as desired. The set of nodes can also have assigned a chronological identity. The chronological identity can designate an order by which the user proceeds through the user path 200. In such a manner, the user path 200 can represent a learning curriculum for the user comprising the education media associated with the set of nodes.

The different levels of metadata are illustrated in FIG. 2 as different dashed lines surrounding each node. For example, slide decks and/or presentations can be denoted by solid lines. Video recordings explaining the slide decks can be denoted by dashed lines. Quizzes on the concepts in the slide decks can be denoted by mixed dotted and dashed lines.

The first link 122 can connect the first node 112 and the second node 114, and the second link 124 can connect the first node 112 and a third node. Each of the links can represent an educational relationship between the at least two nodes. For example, the first link 122 can indicate that the second node 114 is a quiz designed to test a user's understanding of the concept in the first node 112. Alternatively, or in addition, the second link 124 can be the opposite of the first link 122, linking the second node 114 back to the first node. For example, the second link 124 can indicate that the first node 112 conceptualizes the second node 114. Further, the second link 124 can link the second node 114 to the third node. It is understood that the plurality of links 120 can link the plurality of nodes 110 together in a variety of ways as desired by those of ordinary skill in the art. In such a manner, the knowledge graph 100 can classify learning material in the plurality of nodes 110 and establish the relationships between them using the plurality of links 120.

As the user progresses through the learning path, the learning medium associated with each node can be retrieved from a database and presented to the user on the GUI. The user path 200 can also be altered to remove additional nodes based on environmental data associated with the user, as will be described in greater detail below.

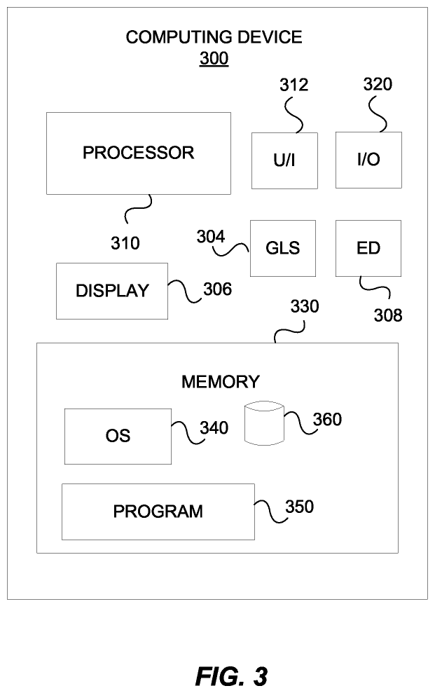

An example embodiment of a computing device 300 which can be used to execute or in conjunction with the processes, systems, and methods disclosed herein is shown in more detail in FIG. 3. While FIG. 3 is illustrated and described with respect to the computing device 300, it is to be understood that the example of the computing device 300 is merely illustrative, and that the illustrations within FIG. 3 can correspond to one or more components of other general-purpose computers, cloud systems, servers, and the like.

As shown, the computing device 300 can include a processor 310; an I/O device 320; a memory 330 containing an OS 340; a storage device 360, which can be any suitable repository of data and can include a database with any number of locations; and a program 350. In some examples, the computing device 300 can include components such as an accelerometer; a gyroscope; a GLS 304 for determining the geographic location of the computing device 300; a display 306 (e.g., a GUI) for displaying content such as text messages, images, and selectable buttons/icons/links; an environmental data (“ED”) sensor 308 for obtaining environmental data including audio and/or visual information; a U/I device 312 for receiving user input data, such as data representative of a click, a scroll, a tap, a press, or typing on an input device that can detect tactile inputs; a display; a microphone and/or an image capture device, such as a digital camera. In some examples, the computing device 300 can include a transceiver. In some examples, the computing device 300 can further include a peripheral interface, a mobile network interface in communication with the processor 310, a bus configured to facilitate communication between the various components of the computing device 300, and/or a power source configured to power one or more components of the computing device 300.

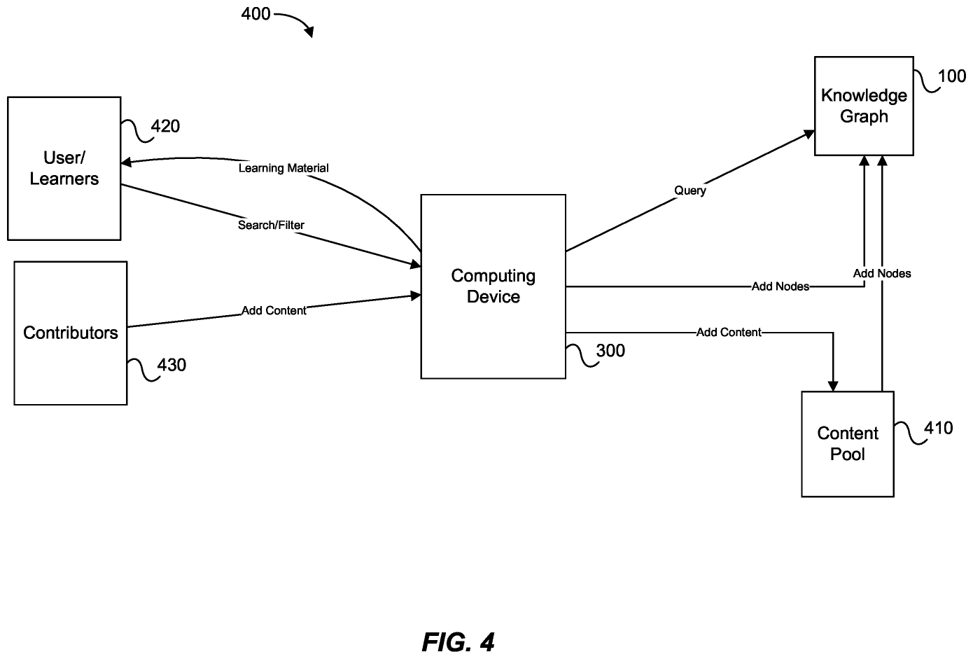

FIG. 4 illustrates a knowledge graph system 400. As shown, the knowledge graph system 400 can comprise the computing device 300, the knowledge graph 100, and a database 410 (e.g., content pool). The computing device 300 can be the computing device as illustrated in FIG. 3 or any other computing device capable of performing similar functions. The database 410 can be any virtual or physical database, such as a hard drive or a cloud database. As shown, the computing device 300 can also be in communication with a user 420 and/or a contributor 430. The user 420 and/or the contributor 430 can be interacting directly with the computing device 300 or on their own respective computing devices which are in communication with the computing device 300 (e.g., on a user device associated with the user 420).

As described above, the user device associated with the user/learners 420 can be similar to the computing device 300, having any or all of the components described therein. Alternatively, the user device and the computing device 300 can be one singular device to perform some or all of the functionalities described herein. As used herein, the terms user 420 learners 420 are intended to be interchangeable.

As described above, the knowledge graph 100 can comprise a plurality of nodes 110 (e.g., a first node 112 and a second node 114) and a plurality of links 120 (e.g., a first link 122 and a second link 124). The knowledge graph system 400 can classify the plurality of nodes 110. Each of the plurality of nodes 110 can represent an education medium. For example, the plurality of nodes 110 can each represent pieces of learning content, such as presentation recordings, slideshows, videos, quizzes, and the like. Alternatively, or in addition, each of the plurality of nodes 110 can comprise metadata associated with the education medium. The metadata can include, for example, a type of content, a level of difficulty, an intended audience, a time to complete, or an author of the education medium. The plurality of nodes 110, therefore, can represent a default learning curriculum that is provided to the user/learners 420.

Each of the plurality of links 120 can connect to at least two nodes of the plurality of nodes 110. The knowledge graph system 400 can establish the plurality of links 120 based on an education relationship between the plurality of nodes 110. For example, the first link 122 and the second link 124 can connect the first node 112 and the second node 114. Each of the links can represent an educational relationship between the at least two nodes. For example, the first link 122 can indicate that the second node 114 is an example of the concept in the first node 112. Alternatively, or in addition, the second link 124 can indicate that the first node 112 conceptualizes the second node 114. In such a manner, the knowledge graph 100 can classify learning material in the plurality of nodes 110 and establish the relationships between them using the plurality of links 120.

The knowledge graph 100 can be displayed on a graphical user interface (GUI) on a user device associated with the learners 420 such that the plurality of nodes 110 and the plurality of links 120 are visible to the user 420 and/or the contributor 430. The knowledge graph 100 can be illustrated as shown in FIG. 1 or in other manners contemplated by those of skill in the art. The GUI can further display the metadata associated with each of the plurality of nodes 110 or the plurality of links 120, as well as other information described above. For example, a given node can be labeled “Coding 101” on the GUI with additional display elements indicating “Level of Difficulty: Easy” and “Time to Complete: 10 Minutes.”

The computing device 300 can receive data representative of qualifications associated with the user/learners 420. The data can be input to the computing device 300 directly by the user/learners 420 or received from a computing device associated with the user/learners 420. The qualifications associated with the user 420 can comprise, for example, job family, years of experience, current time availability, or current project type, and the like. The qualifications can be manually input by the user 420, or the qualifications can be determined from metadata associated with the user 420 and/or the computing device associated with the user 420.

The computing device 300 can then determine a first set of nodes from the plurality of nodes 110 representing education media known by the user 420. The determination can be made based on the qualifications associated with the user 420. In such a manner, certain nodes (represented by the first set of nodes) that contain subject matter already known by the user 420 or too basic for the user 420 can be identified.

The computing device 300 can then filter out the first set of nodes from the plurality of nodes 110. The computing device 300 can also filter out the first set of nodes from the GUI such that the first set of nodes is no longer visible on the GUI. In such manner, the user 420 can view a GUI that is uncluttered by redundant or known learning material. Alternatively, the computing device 300 can sort out the first set of nodes prior to providing the plurality of nodes to the user/learners 420. In such a manner, the user/learners 420 need not see the first set of nodes and can focus only on the nodes which need to be completed.

The computing device 300 can then create a user path, such as the user path 200 through the knowledge graph 100. The user path 200 can comprise a second set of nodes from the plurality of nodes 110. As would be understood, the second set of nodes can comprise the nodes that are not removed and/or filtered out in the first set of nodes. As shown, each of the nodes in the second set of nodes in the user path 200 can be connected to other nodes by links from the plurality of links 120. The user path 200 can also be highlighted or otherwise emphasized on the GUI. In such a manner, the computing device 300 can draw the attention of the user 420 to the user path 200, or the computing device 300 can generally make the user path 200 more identifiable and/or aesthetically pleasing such that the user 420 is encouraged to proceed through the user path 420.

The second set of nodes in the user path 200 can each also have assigned a chronological identity. The chronological identity can designate an order by which the user 420 proceeds through the user path 200. The chronological identity can be representative of a level of difficulty for each learning medium in each node. For example, the chronological identities can arrange the user path 200 from easy learning material to difficult learning material. The level of difficulty can be determined from the metadata associated with each node. In such a manner, the user path 200 can represent a learning curriculum for the user 420 comprising the education media associated with the second set of nodes. As the user 420 progresses through the user path 200, the learning medium associated with each node can be retrieved from the database 410 and presented to the user 420 on the GUI.

The user path 200 can also be altered to remove additional nodes based on environmental data associated with the user 420. The computing device 300 can comprise the ED sensor 308 for receiving environmental data. For example, the environmental data can be used to determine a current time based on receiving visual data based on a current lighting level. Based on the current time associated with the user 420, the computing device 300 can determine a level of engagement associated with the user. For example, if the ED sensor 308 determines that the user 420 is accessing the user path late at night, the computing device 300 can determine that the level of engagement is likely to be low. In response, the computing device 300 can remove additional nodes from the user path 200. For instance, the computing device 300 can remove nodes that have an associated education medium with lengths longer than 15 minutes. The lengths can be determined from the metadata associated with each node.

Other examples of environmental data that can be used and obtained by the ED sensor 308 can include but are not limited to: a time of day, a day of the week, a location, a workload, a current sound level, a level of distractions, and the like.

Furthermore, the computing device 300 can receive a set of constraints for forming a desired learning curriculum. In such a manner, the user 420 can maintain some control over the user path 200 and the learning curriculum. In response, the computing device 300 can alter the user path 200 such that the nodes in the user path 200 match the constraints. For example, the user 420 can indicate that they desire to watch only videos on a specific topic. Then, the computing device 300 can remove the nodes in the user path 200 which do not represent video learning media.

While the following methods may be described with reference to a particular contextualized review system, it is understood that one or more method steps or whole methods can be performed by other contextualized review systems disclosed herein, other systems, general-purpose computers, computer operators, and the like.

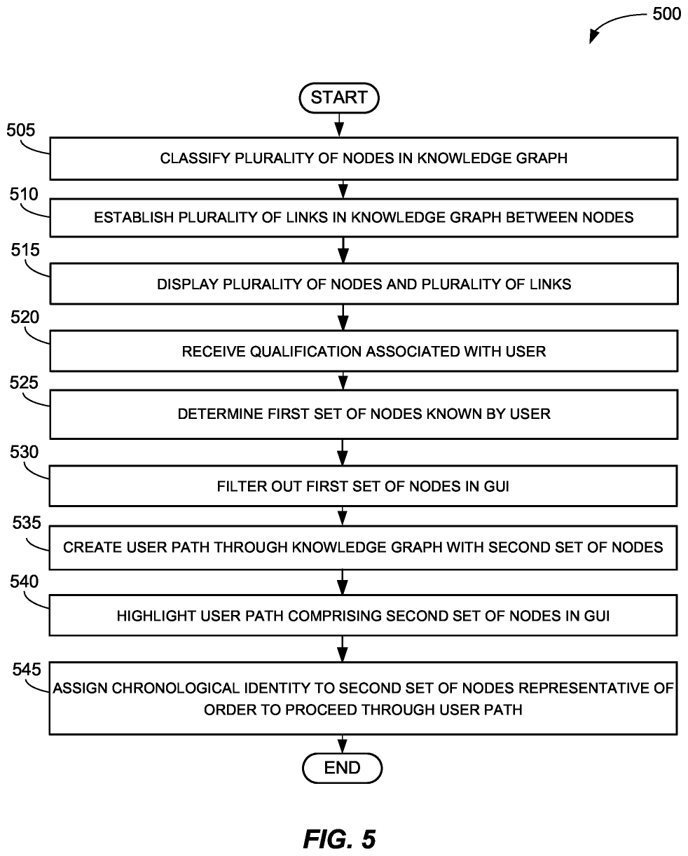

FIG. 5 illustrates a method 500 for generating a user path 200. While the method 500 is described in relationship with the user path 200, the knowledge graph 100, the computing device 300, and the knowledge graph system 400, it is understood that the method 500 can utilize some, all, or none of the components described herein.

In block 505, the knowledge graph system 400 (e.g., by the computing device 300) can classify the plurality of nodes 110. Each of the plurality of nodes 110 can represent an education medium. For example, the plurality of nodes 110 can each represent pieces of learning content, such as presentation recordings, slideshows, videos, quizzes, and the like. Alternatively, or in addition, each of the plurality of nodes 110 can comprise metadata associated with the education medium. The metadata can include, for example, a type of content, a level of difficulty, an intended audience, a time to complete, or an author of the education medium. The method 500 can then proceed on to block 510.

In block 510, the knowledge graph system 400 can establish the plurality of links 120 based on an education relationship between the plurality of nodes 110. For example, the first link 122 and the second link 124 can connect the first node 112 and the second node 114. Each of the links can represent an educational relationship between the at least two nodes. For example, the first link 122 can indicate that the second node 114 is an example of the concept in the first node 112. Alternatively, or in addition, the second link 124 can indicate that the first node 112 conceptualizes the second node 114. In such a manner, the knowledge graph 100 can classify learning material in the plurality of nodes 110 and establish the relationships between them using the plurality of links 120. The method 500 can then proceed on to block 515.

In some embodiments, the knowledge graph system 400 may have previously classified the plurality of nodes 110 and established the plurality of links 120 based on an education relationship between the plurality of nodes 110. Such classification and links may be stored in memory 330 or storage device 360 of computing device 300. Thus, instead of reclassifying the plurality of nodes 110 and reestablishing a plurality of links 120, the knowledge graph system 400 may simply retrieve the previous classifications and links 120 and proceed to block 515. If, however, there are any newly added nodes 110 due to newly added educational content, then blocks 505 and 510 may be repeated for the new content and how it is linked to the previous content.

In block 515, the knowledge graph system 400 may cause a user device 420 (e.g., the learners 420) associated with a user 420 to display on a graphical user interface (GUI) on the user device 420 such that the plurality of nodes 110 and the plurality of links 120 are visible to the user 420 and/or the contributor 430. The knowledge graph 100 can be illustrated as shown in FIG. 1 or in other manners contemplated by those of skill in the art. The GUI can further display the metadata associated with each of the plurality of nodes 110 or the plurality of links 120, as well as other information described above. For example, a given node can be labeled “Coding 101” on the GUI with additional display elements indicating “Level of Difficulty: Easy” and “Time to Complete: 10 Minutes.” The method 500 can then proceed on to block 520.

In block 520, the knowledge graph system 400 may receive data representative of qualifications associated with the user 420 via the user device. The data can be input to the computing device 300 directly by the user 420 or received from a user device associated with the user 420. The qualifications associated with the user 420 can comprise, for example, job family, years of experience, current time availability, or current project type, and the like. The qualifications can be manually input by the user 420, or the qualifications can be determined from metadata associated with the user 420 and/or the computing device associated with the user 420. The method 500 can then proceed on to block 525.

In block 525, the knowledge graph system 400 may then determine a first set of nodes from the plurality of nodes 110 representing education media known by the user 420. The determination can be made based on the qualifications associated with the user 420. In such a manner, certain nodes (represented by the first set of nodes) that contain subject matter already known by the user 420 or too basic for the user 420 can be identified. The method 500 can then proceed on to block 530.

In block 530, the knowledge graph system 400 may then filter out the first set of nodes from the plurality of nodes 110. The knowledge graph system 400 may cause the user device 420 to filter out the first set of nodes from the GUI such that the first set of nodes is no longer visible on the GUI. In such manner, the user 420 can view a GUI that is uncluttered by redundant or known learning material. The method 500 can then proceed on to block 535.

In block 535, knowledge graph system 400 may then create a user path, such as the user path 200 through the knowledge graph 100. The user path 200 can comprise a second set of nodes from the plurality of nodes 110. As would be understood, the second set of nodes can comprise the nodes that are not removed and/or filtered out in the first set of nodes. As shown, each of the nodes in the second set of nodes in the user path 200 can be connected to other nodes by links from the plurality of links 120. The method 500 can then proceed on to block 540.

In block 540, the knowledge graph system 400 may cause the user device 420 to highlight or otherwise emphasize the user path 200 on the GUI. In such a manner, the user device 420 can draw the attention of the user 420 to the user path 200, or the user device 420 can generally make the user path 200 more identifiable and/or aesthetically pleasing such that the user 420 is encouraged to proceed through the user path 420. The method 500 can then proceed on to block 545.

In block 545, knowledge graph system 400 may assign a chronological identity to the second set of nodes in the user path 200. The chronological identity can designate an order by which the user 420 proceeds through the user path 200. The chronological identity can be representative of a level of difficulty for each learning medium in each node. For example, the chronological identities can arrange the user path 200 from easy learning material to difficult learning material. The level of difficulty can be determined from the metadata associated with each node. In such a manner, the user path 200 can represent a learning curriculum for the user 420 comprising the education media associated with the second set of nodes. As the user 420 progresses through the user path 200, the learning medium associated with each node can be retrieved from the database 410 and presented to the user 420 on the GUI. The method 500 can then terminate after block 545; however, the method 500 can also proceed on to other method steps not explicitly shown.

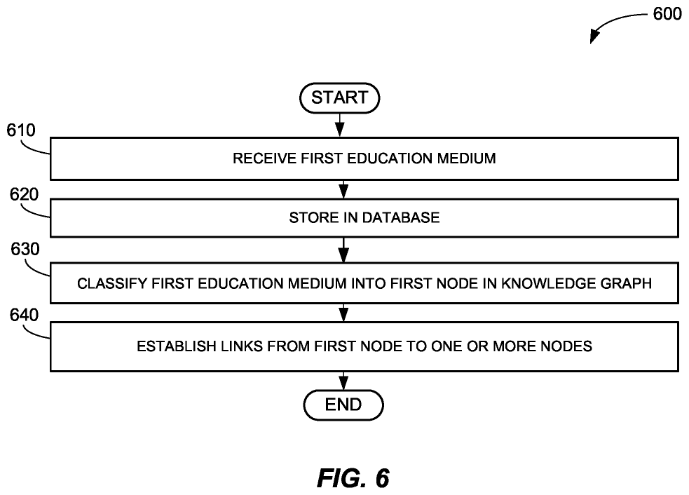

FIG. 6 illustrates a method 600 of generating a learning curriculum. While the method 600 is described in relationship with the user path 200, the knowledge graph 100, the computing device 300, and the knowledge graph system 400, it is understood that the method 500 can utilize some, all, or none of the components described herein.

In block 610, the computing device 300 can receive a first education medium from a contributor 430. The first education medium can be received directly from the contributor 430 or from a computing device associated with the contributor 430. The first education medium can include data representative of a contents thereof, such as metadata associated with the first education medium. Suitable examples of data included in the metadata are described above. The method 600 can then proceed on to block 620.

In block 620, the computing device 300 can store the first education medium in the database 410. Any associated metadata can also be stored in the database 410. The method 600 can then proceed on to block 630.

In block 630, the computing device 300 can classify the first education medium into a node (e.g., the first node 112) in the knowledge graph 100. The first node 112 can include a query path to the location of the first education medium in the database 410. The first node 112 can also include the metadata associated with the first education medium and received from the contributor 430. The method 600 can then proceed on to block 640.

In block 640, the computing device 300 can establish one or more links from the first node 112 to one or more nodes in the knowledge graph 100 based on the contents of the first education medium. Each of the one or more links can represent a relationship between the first education medium and one or more education media associated with the one or more nodes. The method 600 can then terminate after block 640; however, the method 600 can also proceed on to other method steps not explicitly shown.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

While the present disclosure has been described in connection with a plurality of exemplary aspects, as illustrated in the various figures and discussed above, it is understood that other similar aspects can be used, or modifications and additions can be made, to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

### Exemplary Use Cases

The following exemplary use cases describe examples of a typical user flow pattern. They are intended solely for explanatory purposes and not limitation.

A computing device 300 can classify a plurality of nodes 110 in a knowledge graph 100. The plurality of nodes 110 can each be associated with a piece of learning material, and the knowledge graph 100 can be associated with a company's entire learning library. The computing device 300 can establish a plurality of links 120 representing relationships between the plurality of nodes in the knowledge graph 100.

The computing device 300 can receive qualifications from a user 420. The qualifications can indicate that the user was a front-end JavaScript developer in their previous job for 7 years. The user 420 can also indicate that they wish to proceed through the company's learning material on JavaScript to integrate to a new project that they have been assigned to. Based on the qualifications, the computing device 300 can filter out all non-JavaScript material because the user 420 asked for learning material about JavaScript. Then, the computing device 300 can filter out the nodes that are associated with beginner learning material for JavaScript. The computing device 300 can determine which nodes represent beginner learning material due to the metadata stored in each node.

The remaining nodes can be assembled in a user path 200 through the knowledge graph 100. The user path 200 can comprise nodes with learning material that the user 420 requested. The user path 200 can be displayed and/or highlighted on a display and presented to the user 420. Each node in the user path 200 can have a chronological identity indicating the manner in which the user 420 is to proceed through the user path 200.

In another example, a contributor 430 can create a podcast recording discussing advanced sorting algorithms in Python. The contributor 430 can transmit the podcast recording to the computing device along with metadata related to the podcast recording. The computing device 300 can receive the podcast recording as well as metadata indicating a runtime of 32 minutes and a level of difficulty of advanced. The computing device 300 can store the podcast recording audio file in a database 410. In a knowledge graph 100 representing the learning library of an entire company, the computing device can classify the podcast recording into a first node in the knowledge graph 100. The computing device 300 can classify the podcast recording as an audio recording relating to Python and sorting algorithms. The first node can also contain the metadata including the runtime and the level of difficulty. Then, the computing device 300 can establish links from the first node to a second node representing a slideshow on basic sorting algorithms and a third node representing a white paper on automating the sorting process using machine learning. The link from the first node to the second node can indicate that the second node is the basis for learning the first node, and the link from the first node to the third node can indicate that the first node is an introduction to the third node.

What is claimed is:

1. A method for generating a user path, the method comprising:
classifying a plurality of nodes in a knowledge graph, each of the plurality of nodes representative of an education medium;
establishing a plurality of links in the knowledge graph, each of the plurality of links connecting to at least two nodes of the plurality of nodes, each of the plurality of links representative of an education relationship between the at least two nodes;
causing a computing device associated with a user to display, on a graphical user interface (GUI) the plurality of nodes and the plurality of links;
receiving, from the computing device associated with the user, data representative of qualifications associated with the user;
determining, based on the qualifications associated with the user, a first set of nodes from the plurality of nodes, the first set of nodes representative of education mediums known by the user;
causing the computing device to filter out, from the GUI, the first set of nodes such that the first set of nodes are no longer visible on the GUI;
creating a user path through the knowledge graph, the user path comprising a second set of nodes from the plurality of nodes, each node in the second set of nodes connected by a link from the plurality of links;
causing the computing device to highlight, on the GUI, the user path comprising the second set of nodes connected by the plurality of links; and
assigning, to each node in the second set of nodes, a chronological identity representative of an order by which the user proceeds through the user path,
wherein the user path is representative of a learning curriculum comprising the education medium associated with each of the second set of nodes.

2. The method of claim 1, further comprising:
retrieving, from a database, each education medium associated with each node in the second set of nodes; and
transmitting each education medium to the user, thereby displaying each education medium on the GUI of the computing device associated with the user.

3. The method of claim 1, further comprising:
receiving, from the computing device associated with the user, environmental data associated with the user at a current time; and
analyzing, based on the environmental data and the current time associated with the user, a level of engagement associated with the user.

4. The method of claim 3, further comprising removing one or more nodes from the second set of nodes based on the level of engagement.

5. The method of claim 3, wherein the environmental data comprises one or more of: a time of day, a day of the week, a location, or a workload.

6. The method of claim 1, wherein the creating the user path comprises:
receiving, from the computing device associated with the user, a set of constraints indicative of a desired learning curriculum; and
selecting the second set of nodes such that each of the second set of nodes matches the set of constraints.

7. The method of claim 1, wherein each of the plurality of nodes in the knowledge graph comprises metadata associated with the education medium, the metadata comprises one or more of: a type of content, a level of difficulty, an intended audience, a time to complete, or an author of the education medium.

8. The method of claim 1, wherein the chronological identity of each of the second set of nodes is representative of a level of difficulty of each learning medium associated with each node in the second set of nodes.

9. A knowledge graph system comprising:
a processor;
a database; and
a memory storing instructions that, when executed by the processor, cause the knowledge graph system to:
classify a plurality of nodes in a knowledge graph, each of the plurality of nodes representative of an education medium;
establish a plurality of links in the knowledge graph, each of the plurality of links connecting to at least two nodes of the plurality of nodes, each of the plurality of links representative of an education relationship between the at least two nodes;
receive, from a computing device associated with a user, data representative of qualifications associated with the user;
determine, based on the qualifications associated with the user, a first set of nodes from the plurality of nodes, the first set of nodes representative of education mediums known by the user;
create a user path through the knowledge graph, the user path comprising a second set of nodes from the plurality of nodes, each node in the second set of nodes connected by a link from the plurality of links; and
assign, to each node in the second set of nodes, a chronological identity representative of an order by which the user proceeds through the user path,
wherein the user path is representative of a learning curriculum comprising the education medium associated with each of the second set of nodes.

10. The knowledge graph system of claim 9, wherein the instructions further cause the knowledge graph system to:
retrieve, from the database, each education medium associated with each node in the second set of nodes; and
transmit each education medium to the user, thereby granting the user access to each education medium.

11. The knowledge graph system of claim 9, wherein the instructions further cause the knowledge graph system to:
receive, from the computing device associated with the user, environmental data associated with the user at a current time; and
analyze, based on the environmental data and the current time associated with the user, a level of engagement associated with the user.

12. The knowledge graph system of claim 11, wherein the instructions further cause the knowledge graph system to remove one or more nodes from the second set of nodes based on the level of engagement.

13. The knowledge graph system of claim 11, wherein the environmental data comprises one or more of: a time of day, a day of the week, a location, or a workload.

14. The knowledge graph system of claim 9, wherein the creating the user path comprises:
receiving, from the computing device associated with the user, a set of constraints indicative of a desired learning curriculum; and
selecting the second set of nodes such that each of the second set of nodes matches the set of constraints.

15. The knowledge graph system of claim 9, wherein each of the plurality of nodes in the knowledge graph comprises metadata associated with the education medium, the metadata comprises one or more of: a type of content, a level of difficulty, an intended audience, a time to complete, or an author of the education medium.

16. The knowledge graph system of claim 9, wherein the chronological identity of each of the second set of nodes is representative of a level of difficulty of each learning medium associated with each node in the second set of nodes.

17. A method of generating a learning curriculum, the method comprising:
receiving, from a first computing device associated with a contributor, a first education medium comprising data representative of a contents of the first education medium;
storing, in a database, the first education medium;
classifying, based on the data representative of the contents of the first education medium, the first education medium into a first node in a knowledge graph, the first node including a query path to the first education medium in the database; and
establishing, based on the contents of the first education medium, one or more links from the first node to one or more nodes in the knowledge graph, each of the one or more links representative of a relationship between the first education medium and one or more education media associated with the one or more nodes.

18. The method of claim 17, further comprising:
displaying, on a graphical user interface (GUI) at a second computing device associated with a user, a display comprising the first node and the one or more links to one or more nodes;
receiving, from a second computing device associated with a user, data representative of qualifications associated with the user;
creating, based on the qualifications, a user path through the knowledge graph, the user path comprising the first node and the one or more links to the one or more nodes; and
assigning, to the first node and the one or more nodes, a chronological identity representative of an order by which the user proceeds through the user path,
wherein the user path is representative of a learning curriculum comprising the first education medium and the one or more education media.

19. The method of claim 18, further comprising:
retrieving, from the database, each of the one or more education media associated with the one or more nodes and the first education medium associated with the first node; and
transmitting each education medium to the user, thereby displaying each education medium on the GUI of the second computing device associated with the user.

20. The method of claim 18, further comprising:
receiving, from the second computing device associated with the user, environmental data associated with the user at a current time; and
analyzing, based on the environmental data and the current time associated with the user, a level of engagement associated with the user.
